(19) United States
(12) Patent Application Publication
(10) Pub. No.: US 2004/0117514 A1
(43) Pub. Date: Jun. 17, 2004

(54) Multi-function credit card and case

(76) Inventors: David W. Nelms, Lake Forest, IL (US); Rodney A. Dawson, Lake Zurich, IL (US)

Correspondence Address: SIDLEY AUSTIN BROWN & WOOD LLP, 717 NORTH HARWOOD, SUITE 3400, DALLAS, TX, 75201, US

(21) Appl. No.: 10/674,954

(22) Filed: Sep. 30, 2003

Related U.S. Application Data
(60) Provisional application No. 60/415,587, filed on Oct. 2, 2002.

(51) Int. Cl. G06F 3/00

(52) U.S. Cl. 710/1

(57) ABSTRACT

A multiple function credit card and credit card case is provided. The credit card contains card information. A microprocessor and/or other payment or non-payment device is provided in the case and/or card and can be used with a variety of communication methods and for other functions. In a preferred form the microprocessor can communicate with external mechanisms or systems by electronic and other means such as an inductive magnetic track generator, a bluetooth wireless port, an IRDA & IR infra red port, and an RFID/ISO-14443 simulator. An LCD or other display is provided along with a button panel and/or a keyboard in various embodiments or input of data and information to the microprocessor. The microprocessor can also be used to provide the user access to a number of non-financial applications.

### RELATED APPLICATION

This application is based on U.S. Patent Application No. 60/415,587 filed in the United States Patent and Trademark Office on Oct. 2, 2003, the content of which is hereby incorporated by reference.

### BACKGROUND OF THE INVENTION

The present invention relates to a credit card and credit card case capable of performing multiple functions.

Suppliers of conventional credit cards and special value cards desire to have their particular card carried by the user in an accessible position outside of a wallet or a purse, for example on a key loop or key chain, in order to increase the likelihood of card usage. The advantage of having the card accessible outside of a wallet or purse is that the user has the card available at his or her fingertips instead of having to open a purse or wallet and make a choice to use a particular card or payment instrument from among several possible choices.

In order to protect credit cards from theft of the card itself or the card number when the card is carried on a key chain, cases or fobs have been developed for concealing the card. The person using the card normally opens the case or container without unclipping it from the key chain in order to pivot the card to an accessible position so that the card may be used to transfer payment information to a payment mechanism. There are occasions when, in order to use the card, the case or container must be removed from the key chain.

Originally the transfer of payment information from a credit card was accomplished by taking an imprint of the card on an invoice for payment. Raised numbers on the card containing payment information created an imprint on the invoice when a die or roller was slid across the card and invoice. More recently card identification information can be transferred electronically to an electronic payment mechanism, for example, by means of a magnetic stripe containing information that can be read by dragging the card through a magnetic stripe reader. Another type of transfer of card identification information involves use of a microprocessor chip on the card or in the cover of the case that communicates with an associated electronic payment mechanism by a radio signal transmitted from the card to the payment mechanism. Contact chips can also transfer the payment data to an electronic payment device. Information may also be transferred by bar code using a barcode scanner and barcode reader. Advanced technology for the transfer of information by electronic and other means is being developed at an increasingly rapid pace. With the advance of technology in electronics and other areas it is desirable to combine credit card identification or information means with microprocessor, computer and other product capabilities in order to provide a credit card and credit card case capable of performing multiple functions.

### SUMMARY OF THE INVENTION

The present invention provides a multiple function credit card and credit card case.

In one embodiment the invention includes a credit card or other financial instrument and a case for containing the card or financial instrument. Card information is provided for transfer to a payment mechanism. Preferably the card information is capable of being read by an electronic or other payment mechanism without taking a physical imprint of the card. The microprocessor in the card or case may be used as both a payment and a non-payment device.

In another embodiment the invention includes a credit card and credit card case containing a microprocessor along with data input means and means for communication with an external system. The data input means can include a button pad, numeric and/or letter keyboard or touch screen. The communication means can include means for communication by an inductive magnetic track generator, a bluetooth wireless port, IRDA & IR infra red port, and radio frequency identification (RFID)/ISO-14443 simulator and other communication devices.

### BRIEF DESCRIPTION OF THE DRAWINGS

In the drawings, which are not to scale:

FIG. 1A is a plan view of a first embodiment of the credit card and credit card case of the present invention.

FIGS. 1B and 1C show examples of additional LCD displays on the case of FIG. 1A.

FIG. 2 is a plan view of a second embodiment of the invention showing a clam shell type credit card case with the cover in an open position.

FIG. 3 is a plan view of a third embodiment of the invention showing a clam shell type credit card case with the cover in an open position.

FIG. 4 is a schematic diagram of communication and data accumulation architecture between the credit card and/or credit card case of the present invention with backend systems.

### DETAILED DESCRIPTION OF THE PREFERRED EMBODIMENTS

The present invention provides a multi function credit card and credit card case.

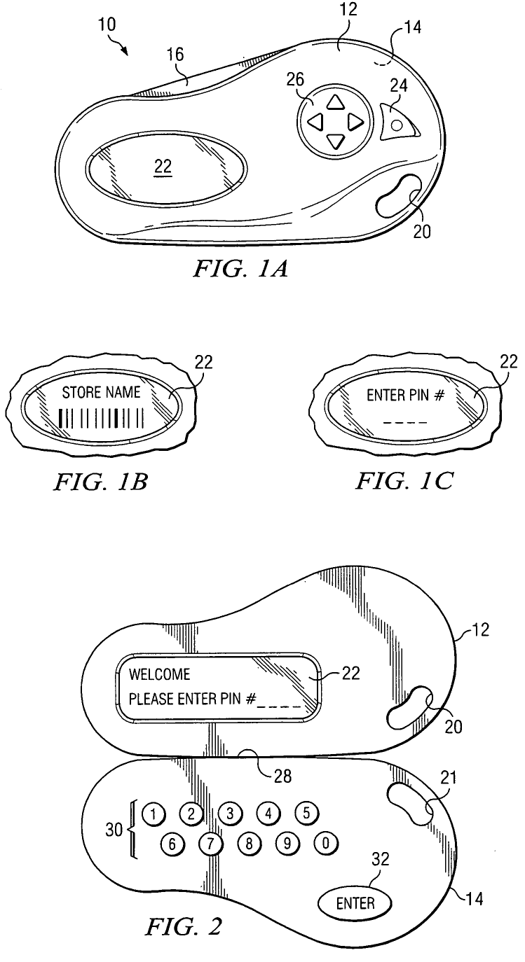

FIG. 1A shows a credit card case 10 having an upper cover portion 12 and a lower cover portion 14. Credit card 16 is pivotally mounted in case 10 on a pivot member. Card 16 partially extends beyond the outer periphery of the case so as to permit the card to be grasped by a person's thumb and forefinger and pivoted to an exposed position upwardly of the case in FIG. 1. The pivot member may be a rivet or post as known in the art. Preferably the card is detachable from the pivot member in order to be fully removed from the case. This may be accomplished by providing a knurled opening in the card, said opening having an open end for the pivotal connection to the pivot member. A description of a card having such an opening and pivotal connection is set forth in PCT/US Patent Application Serial No. PCT/US02/22,933, entitled “Credit Card With Case” filed Jul. 17, 2002, the entire specification of which is incorporated herein by reference. An aperture 20, 21 is provided in upper and lower cover portions 12 and 14 to permit passage of a key chain loop.

According to this invention a non-payment device is provided in the credit card case shown in FIG. 1A and includes an LCD or other display panel 22 activated by on-off button 24. A game-style navigation button 26 is provided for activating a series of bar codes and other displays in panel 22, for example as shown in FIGS. 1B and 1C. The bar code displays are not necessarily associated with the information contained on the credit card, but may be associated with one or more merchant loyalty programs. Thus, the case of the present invention provides a device with one or more bar codes on a single device that can be read by a bar code scanner and reader. The display may also include one or more displays for entry or display of personal identification numbers as in FIG. 1C. A numerical and/or alphabetical keypad for input of numbers and/or letters or to change the displays may also be provided on or inside the case as appropriate or required.

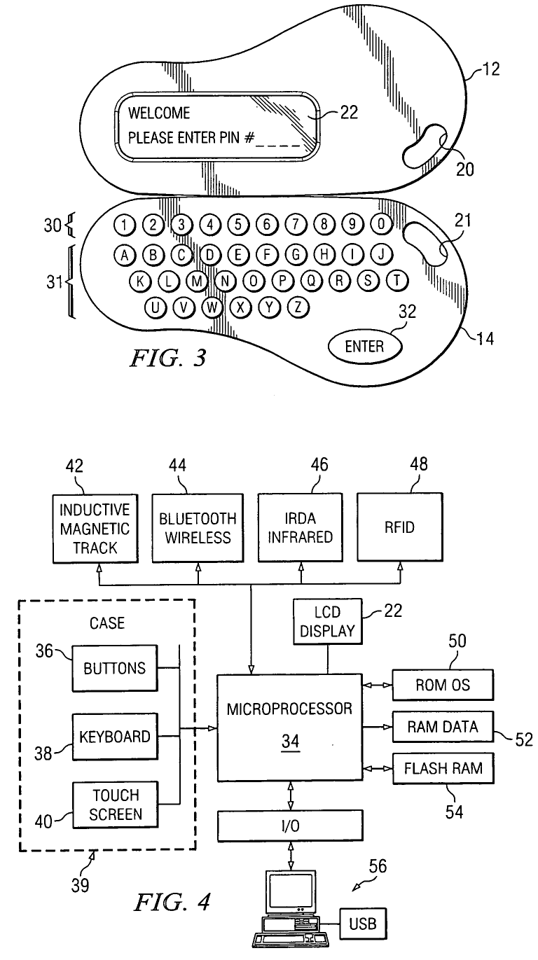

Referring to FIG. 2 a clam shell type of case is shown which includes top cover 12 and lower cover 14 pivotally joined along edge 28. A LCD panel 22 is provided inside of cover 12 for display of bar code and/or other information, such as a prompt to enter a personal identification number as shown in FIG. 2. Numerical keypad 30 is provided inside of cover 14 along with an “enter” button 32 to be pressed upon completion of the entry. FIG. 3 shows a clam shell case having LCD panel 22 inside cover 12 and a numerical 30 and letter or alphabetic keypad 31 inside cover 14 along with enter button 32.

FIG. 4 shows various architecture for communication between the credit card and/or credit card case of the invention and various external systems. Typically the credit card and/or case will include a microprocessor 34 and LCD or other display 22. Entry of information can be made by buttons on button panel 36, keyboard 38 and/or touch screen 40 on a credit card case 39. The microprocessor can communicate with various external electronic and other mechanisms such as inductive magnetic track generator 42, bluetooth wireless port 44, IRDA & IR infra red port 46, and radio frequency identification (RFID)/ISO-14443 simulator 48. The microprocessor typically contains read only memory (ROM) programs and operating system 50, random access memory (RAM) data set 52 and flash RAM 54 preferably of greater than 128 MB. The microprocessor is also capable of communication by serial, universal service buss (USB) port for input/output to an external computer or computer system 56.

Examples of non-payment devices provided with the credit card and case of the invention include a digital clock, stopwatch and/or travel alarm (preferably having multi time zone capability), a USB flash memory device and computer interface, and an LCD bar code generator. Additional non-payment devices provided with the credit card and credit card case can include a mini personal data assistant, calculator, electronic games, short range remote car or garage door control, flashlight, micro text two-way pager, MP3 player, a personal data vault, a personal panic alarm device and other non-payment devices. The case may also include GPS (global positioning satellite) receiver or transmitter functionality in order to use the case as a location determination device.

While a preferred embodiment of the invention has been identified, other configurations and modifications can be provided within the scope of the present invention. For example, it is conceivable that certain of the functions can be provided on the card and/or on the case. It is also conceivable that other advanced means of communication with external mechanisms can be included as they are developed.

We claim:

1. A credit card case, comprising:
an enclosure space for storing a credit card;
a processor;
a display;
a data entry device; and
at least one data communication device.

2. A credit card case as in claim 1, further comprising a pivot pin in the enclosure space, the credit card in enclosure space being exposed by pivoting the credit card about the pivot pin.

3. A credit card case as in claim 1, wherein the processor is a microprocessor integrated with read-only-memory.

4. A credit card case as in claim 1, wherein the display is a liquid crystal display.

5. A credit card case as in claim 1, wherein the data entry device is a navigation button.

6. A credit card case as in claim 1, wherein the data entry device is a key pad.

7. A credit card case as in claim 1, wherein the data communication device is an infrared transmitter.

8. A credit card case as in claim 1, wherein the data communication device is an inductive magnetic track generator.

9. A credit card case as in claim 1, wherein the data communication device is an infrared transceiver.

10. A credit card case as in claim 1, wherein the data communication device is a wireless transceiver.

11. A credit card case as in claim 1, wherein the data communication device is an RFID simulator.

12. A credit card case, comprising:
an enclosure space for storing a credit card;
a processor;
a data entry device; and
a display for displaying a bar code in response to information entered using the data entry device.

13. A credit card case as in claim 12, wherein the display can display a plurality of bar codes in response to a selection entered in the data entry device.

14. A credit card case as in claim 12, wherein the data entry device is a navigation button.

15. A credit card case as in claim 12, wherein the data entry device is a key pad.

16. A credit card case as in claim 12, further comprising a pivot pin in the enclosure space, the credit card in enclosure space being exposed by pivoting the credit card about the pivot pin.

17. A method for providing information necessary for completion of a transaction using a credit card case having an enclosure space for storing a credit card; a processor; a display; a data entry device; and at least one data communication device, the method comprising:
storing transaction information in memory associated with the processor;
selecting the transaction information using the data entry device; and
transmitting the transaction information to a merchant device using the data communication device.

18. A method as in claim 17, wherein the transaction information is merchant loyalty information.

19. A method as in claim 17, wherein the transaction information is identification information.

20. A method as in claim 17, wherein the data entry device is a navigation button.

21. A method as in claim 17, wherein the data entry device is a key pad.

22. A method as in claim 17, further comprising entrain a personal identification number using the data entry device to allow access to the transaction information.

23. A method for providing information necessary for completion of a transaction using a credit card case having an enclosure space for storing a credit card; a processor; a data entry device; and a display for displaying a bar code in response to information entered using the data entry device, the method comprising:
storing transaction information in memory associated with the processor;
selecting the transaction information using the data entry device; and
displaying a bar code representative of the transaction information on the display; and
reading the bar code using a bar code reader.

24. A method as in claim 23, wherein the bar code reader is connected to the merchant's information systems and the transaction information is verified using the merchant's information systems.

25. A method as in claim 23, wherein the transaction information is merchant loyalty information.

26. A method as in claim 23, wherein the transaction information is identification information.

27. A method as in claim 23, wherein the data entry device is a navigation button.

28. A method as in claim 23, wherein the data entry device is a key pad.

29. A method as in claim 23, further comprising entering a personal identification number using the data entry device to allow access to the transaction information.
